(19) United States
(12) Patent Application Publication
(10) Pub. No.: US 2010/0214185 A1
(43) Pub. Date: Aug. 26, 2010

(54) PLASTIC WAVEGUIDE-FED HORN ANTENNA

(75) Inventors: Firas Sammoura, Melrose, MA (US); Liwei Lin, Castro Valley, MA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Regents of the University of California, Oakland, CA (US)

(21) Appl. No.: 12/513,496

(22) PCT Filed: Nov. 1, 2007
(86) PCT No.: PCT/US07/83292

§ 371 Date: May 3, 2010

Related U.S. Application Data
(60) Provisional application No. 60/856,188, filed on Nov. 1, 2006.

(51) Int. Cl. H01Q 13/02; C25D 3/48

(52) U.S. Cl. 343/776; 343/786; 156/151

(57) ABSTRACT

A plastic, waveguide-fed, horn antenna is manufactured using a three-dimensional (3D), polymeric micro hot embossing process. Two cavity resonators may be designed to reduce the impedance mismatch between the pyramidal horn antenna and the feeding waveguide. The waveguide-fed antenna may be fabricated using a self-aligned 3D plastic hot embossing process followed by a selective electroplating and sealing process to coat an approximately 8 μm-thick gold layer around the internal surfaces of the system. As such, this plastic, low-cost manufacturing process may be used to replace the expensive metallic components for millimeter-wave systems and provides a scalable and integrated process for manufacturing an array of antenna.

### CROSS-REFERENCES TO RELATED APPLICATIONS

The present application claims priority to U.S. Provisional Patent Application No. 60/856,188, filed Nov. 1, 2006, the teachings of which are incorporated herein by reference.

### STATEMENT AS TO RIGHTS TO INVENTIONS MADE UNDER FEDERALLY SPONSORED RESEARCH AND DEVELOPMENT

A part of this invention was made with Government support under Grant (Contract) No. DMI-0428884 awarded by the National Science Foundation. The Government has certain rights to this invention.

### BACKGROUND OF THE INVENTION

The present invention relates to antenna devices, and particularly to methods for manufacturing antenna devices.

An antenna is a key element in radar systems for applications in airplanes, astronomy and other detectors (see, e.g., J. B. Mead, A. L. Pazmany, S. M. Sekelsky, and R. E. McIntosh, “Millimeter-wave radars for remotely sensing clouds and precipitation,” Proceedings of the IEEE, vol. 82, no. 12, pp. 1891-1906, December 1994). Millimeter-wave antennas can be categorized into two major categories: (1) leaky-wave antennas composed of open millimeter-waveguides and (2) integrated antennas consisting of radiating structures integrated with solid-state devices that provide signal processing or control functionality (see, F. K. Schwering, “Millimeter Wave Antennas,” Proceedings of the IEEE, vol. 80, no. 1, pp. 92-102, January 1992). For instance, Schwering et al. have demonstrated a leaky-wave antenna consisting of a uniform dielectric waveguide with a periodic surface perturbation (see, F. Schwering and S. T. Peng, “Design of dielectric grating antennas for millimeter wave applications,” IEEE Trans. Millimeter-wave Theory Tech., vol. MTT-31, pp. 199-209, February 1983). Rav-Noy el al. have demonstrated an antenna receiving array integrated with parallel Schottky diodes as an imaging array operating at 94 GHz for plasma diagnostics (see, Z. Rav-Noy, C. Zah, U. Schreter, D. B. Rutledge, T. C. Wang, S. E. Schwartz, and T. F. Kuech, “Monolithic Schottky diode imaging arrays at 94 GHz,” in Dig. Infrared and Millimeter Wave Conf., Miami Beach, Fla., December 1983).

3D metallic waveguides and horn antennas have advantages over the microstrip structure based coplanar antennas in performance and power carrying capability (see, David M. Pozar, Microwave Engineering, (John Wiley & sons, 1997)). Recently, research efforts have begun to utilize micromachining technologies to make antennas. For example, Shenouda el al. have reported silicon micromachined diamond-shape horn antennas operating at 94 GHz using anisotropic silicon etching to construct the 3D horn flare angle while using manual assembly to connect the two silicon dice (see, B. Shenouda, L. W. Pearson, J. E. Harriss, W. Wang, Y. Guo, “Etched-silicon micromachined waveguides and horn antennas at 94 GHz,” IEEE Antennas and Propagation Society International Symposium, vol. 2, pp. 988-991, New York, N.Y., 1996). However, such antennas using metallic components are expensive to manufacture. While plastic rectangular waveguides using a 2D plastic hot-embossing process have been demonstrated (see, Firas Sammoura, Yu-Chuan Su, Ying Cai, Chen-Yu Chi, Bala Elamaran, Liwei Lin and Jung-Chih Chiao, “Plastic 95-GHz Rectangular Waveguides By Micro Molding Technologies,” Sensors and Actuators -A: Physical, Vol. 127, pp. 270-275, 2006), such a technique is not available for 3D antennas. Therefore, while known techniques exist for the manufacture of 3D metallic horn antenna by joining separate metallic pieces, they tend to be expensive and suited for simple pieces. Moreover, such techniques don't lend themselves to the manufacture of an array of such antenna in an integrated manufacturing process.

Therefore, there exists a need for a less expensive method of manufacturing a 3D waveguide-fed horn antenna that is scalable for manufacturing an array of such antennas.

### BRIEF SUMMARY OF THE INVENTION

The present invention is directed to a method for manufacturing a waveguide-fed horn antenna using a three-dimensional, polymeric molding process. An upper mold piece and a lower mold piece are pressed together to form a plastic work piece with a horn pattern and a waveguide pattern. An electroplating seed layer is deposited onto the molded plastic work piece, which is surrounded with a substrate also having an electroplating seed layer. At least a portion of the molded plastic work piece and the substrate is electroplated and sealed to deposit a gold layer thereon and connect the two pieces.

In related aspects, two cavity resonators may be provided in the antenna to reduce impedance mismatch between the horn pattern and the waveguide pattern. The upper and lower mold pieces may be aligned using a key and slot arrangement, which may have a tolerance of less than 25 μm. The electroplating seed layer may be sputtered and may comprise a 200 Å/6000 Å of Cr/Pt. A flange adaptor may also be fabricated via hot embossing and press fitted at the waveguide end. The electroplated metallic layer may be a gold layer approximately 8 μM thick. The mold pieces may be heated to 320° F. and may be pressed together with a pressure of approximately 22.64 KPsi. The plastic work piece may be a Topas COC polymer. The plastic work piece can also be made from any other suitable plastic.

Another aspect of the present invention is directed to a waveguide-fed, horn antenna that includes a plastic body having a horn pattern and a waveguide pattern therein. A metallic layer is deposited on at least a portion of the plastic body.

In one embodiment the present invention provides a method for manufacturing a waveguide-fed horn antenna using a three-dimensional, polymeric molding process. The method includes: pressing an upper mold piece and a lower mold piece together to form a plastic work piece with a horn pattern and a waveguide pattern; depositing an electroplating seed layer onto the molded plastic work piece; surrounding the embossed plastic work piece with a substrate having an electroplating seed layer; and electroplating and sealing at least a portion of the molded plastic work piece and the substrate to deposit a metallic layer thereon and connect the plastic work piece with the substrate.

In one aspect, the method also includes providing cavity resonators in the antenna to reduce impedance mismatch between the horn pattern and the waveguide pattern.

In another aspect, the method also includes aligning the upper and lower mold pieces using a key and slot arrangement.

In one aspect, the polymeric molding process can be a hot embossing or an injection molding.

In another aspect, the deposition of an electroplating seed layer can include the sputtering of a seed layer. The sputtering can include sputtering a 200 Å/6000 Å of Cr/Pt.

In another aspect, the method also includes fabricating a flange adaptor and press fitting the adaptor at the waveguide end.

In another aspect, the metallic layer can be gold.

In another aspect, the substrate can be an aluminum substrate.

In another aspect, the substrate can be a plastic substrate.

In another aspect, the horn pattern can include a pyramidal shape.

In another aspect, the waveguide pattern can include a rectangular shape.

In another aspect, the plastic work piece can be made from a Topas COC polymer.

In another embodiment, the present invention provides a waveguide-fed, horn antenna that includes a plastic body having a horn pattern and a waveguide pattern therein; and a metallic layer deposited on at least a portion of the plastic body.

In one aspect, the waveguide-fed, horn antenna also includes two cavity resonators for reducing impedance mismatch between the horn pattern and the waveguide pattern.

In another aspect, the waveguide-fed, horn antenna also includes a flange adaptor press fitted at an end of the waveguide pattern.

In another aspect, the plastic body can be made from a Topas COC polymer.

In another embodiment, the present invention provides a method for manufacturing a waveguide-fed horn antenna using a three-dimensional, polymeric molding process. The method includes: pressing an upper mold piece and a lower mold piece together to make a plastic work piece with a horn pattern and a waveguide pattern; depositing a metal layer onto the embossed plastic work piece; surrounding the embossed plastic work piece with a second substrate having a metal layer on the surface; and sealing at least a portion of the molded plastic work piece with second substrate to connect the two pieces.

In one aspect, the method also includes providing two cavity resonators in the antenna to reduce impedance mismatch between the horn pattern and the waveguide pattern.

In one aspect, the second substrate is made of plastic material.

In another embodiment, the present invention provides a method for manufacturing a waveguide-fed horn antenna array using a three-dimensional, polymeric molding process, where the method includes: pressing an upper mold piece and a lower mold piece together to hot emboss a plastic work piece with a horn pattern array and a waveguide network pattern; depositing a metal layer onto the embossed plastic work piece; surrounding the embossed plastic work piece with a substrate having a metal layer on the surface thereof; sealing at least a portion of the molded plastic work piece with the substrate to connect the work piece with the substrate; and providing cavity resonators in each of the antenna to waveguide connections to reduce impedance mismatch between the horn pattern and the waveguide pattern.

In one aspect, the second substrate is made of plastic material.

In another aspect, all manufactured antennas in the antenna array are of the same shape and size.

In another aspect, the present invention provides a waveguide-fed, horn antenna array that includes: a plastic body having a horn pattern array and a waveguide network pattern therein; and a metallic layer deposited on at least a portion of the system.

In one aspect, the antennas of the array are W-band antennas.

In another aspect, all antennas in the antenna array have the same shape and size.

In another aspect, the waveguide network pattern is a part of an array of network patterns, which patterns have different lengths and shapes.

As such, this plastic, low-cost manufacturing process may be used to replace the expensive metallic components for millimeter-wave systems and provides a scalable and integrated process for manufacturing an array of antennas.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 is an illustrative schematic diagram of a W-band waveguide-fed horn antenna;

FIG. 2 shows E- and H-planes cross sectional views of a pyramidal horn;

FIG. 3 illustrates the simulation result of waveguide-fed horn dimensions versus gain based on a WR-10 waveguide;

FIG. 4 illustrates a parametric design using HFSS to calculate the S₁₁ responses with respect to L₁ by setting L₂ value as zero;

FIGS. 5(a)-(d) illustrate the fabrication process of the waveguide-fed horn antenna in accordance with one embodiment of the present invention;

FIG. 6(a) is a close-up view at the horn of the waveguide-fed horn antenna fabricated in accordance with one embodiment of the present invention;

FIG. 6(b) is a close-up view at the flange of the wave-guide horn antenna of FIG. 6(a);

FIG. 7 illustrates the simulated radiation patterns of the antenna for the co-polarized E and H-planes using HFSS, whereby at 95 GHz, the directivity in the E and H-planes is 16.56 dB;

FIG. 8 illustrates the testing set-up for the horn antenna tests for co-polarized H-plane measurement;

FIG. 9 is a graph of the measured radiation patterns of the horn antenna for both co-polarized E and H-planes, whereby at 95 GHz, the directivity in the E and H-planes is 17.33 dB;

FIG. 10 is a simplified schematic diagram showing two antennas separated by a distance R, whereby the receiver antenna has a gain and received power of G₀ᵣ, and Pᵣ respectively, while the transmitter antenna has a gain and received power of G₀ₜ and Pₜ respectively;

FIG. 11 is a graph of the simulated and measured return loss of the waveguide-fed horn antenna, whereby the measured 10 dB impedance bandwidth is 22 GHz;

FIG. 12 is a graph of the measured radiation patterns of the horn antenna from the H-plane co-polarized and cross-polarized fields; and

FIG. 13 is a graph of the measured radiation patterns of the horn antenna from the E-plane co-polarized and cross-polarized fields.

### DETAILED DESCRIPTION OF THE INVENTION

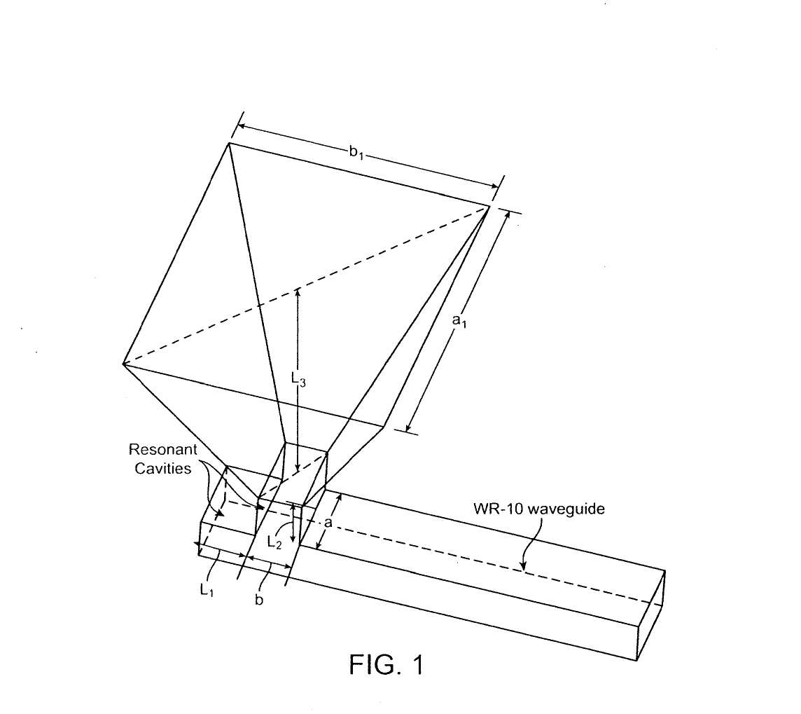

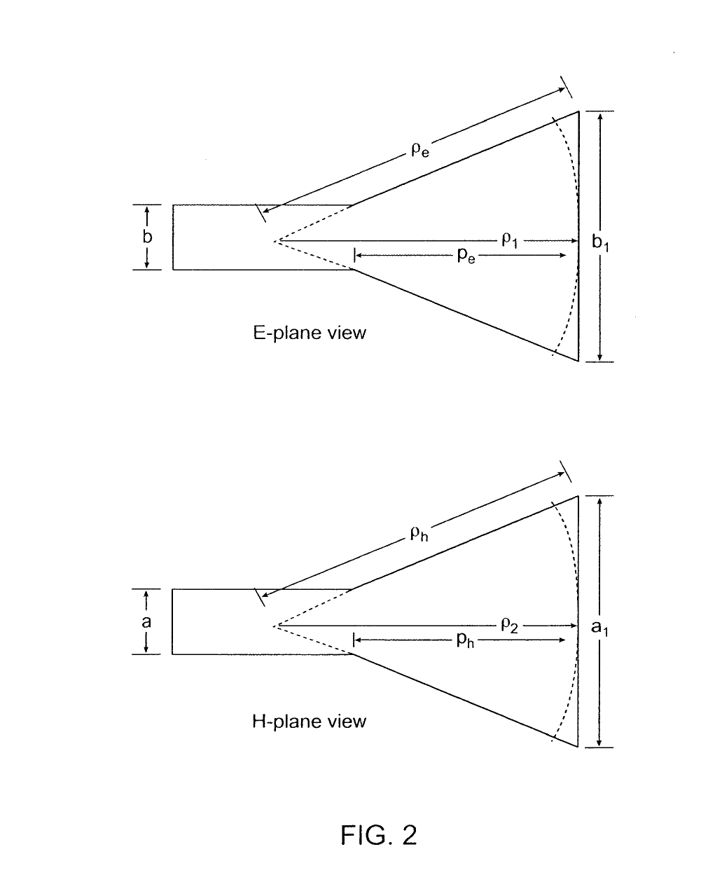

FIG. 1 shows the schematic diagram of a waveguide-fed horn antenna. A pyramidal horn, which is flared in both the E- and H-planes, is used. The radiation characteristics of a pyramidal horn are a combination of the E- and H-plane cross sectional views shown in FIG. 2. The design of the pyramidal horn can use the optimum gain method by specifying the dimensions of the waveguide and the desired antenna gain. In order to physically realize a pyramidal horn, the height of the pyramidal horn, L₃ in FIG. 1 (P_{H} or P_{E} in FIG. 2) can be given by (see, Constantine A. Balanis, Antenna Theory: Analysis and Design, (John Wiley, 1997), pp. 651-721):

$$\begin{matrix}{p}_{H} = {( {a}_{1} - a ) [ {( \frac{{ρ}_{H}}{{a}_{1}} )}^{2} - \frac{1}{4} ]}^{1 / 2} & ( 1 ) \\ {p}_{E} = {( {b}_{1} - b ) [ {( \frac{{ρ}_{E}}{{b}_{1}} )}^{2} - \frac{1}{4} ]}^{1 / 2} & ( 2 )\end{matrix}$$

The gain, Gₒ, of a horn antenna is related to its physical area and the operation wavelength, λ, and is given as follows (see, Constantine A. Balanis, Antenna Theory: Analysis and Design, (John Wiley, 1997), pp. 651-721):

$${G}_{o} = \frac{1}{2} \frac{4 π}{{λ}^{2}} ( {a}_{1} {b}_{1} ) \qquad ( 3 )$$

The maximum directivity for the H-plane horn and E-plane horn occurs when the horn widths flare a₁ and b₁ are given by (see, Constantine A. Balanis, Antenna Theory: Analysis and Design, (John Wiley, 1997), pp. 651-721):

a₁≅\sqrt{2λρ_{E}} (4)

b₁≅\sqrt{2λρ_{H}} tm 5)

For a pyramidal horn with sizeable depth, one may approximate ρ₂≅ρₕ and ρ₁≅ρₑ, so that Eq. (3) is reduced to (see, Constantine A. Balanis, Antenna Theory: Analysis and Design, (John Wiley, 1997), pp. 651-721):

$$\begin{matrix}{( \sqrt{2 χ} - \frac{b}{λ} )}^{2} ( 2 χ - 1 ) = {( \frac{{G}_{o}}{2 π} \sqrt{\frac{3}{2 π}} \frac{1}{\sqrt{χ}} - \frac{a}{λ} )}^{2} ( \frac{{G}_{o}^{2}}{6 {π}^{3}} \frac{1}{χ} - 1 ) \\ where & ( 6 ) \\ \frac{{ρ}_{E}}{λ} = χ \\ and & ( 7 ) \\ \frac{{ρ}_{H}}{λ} = \frac{{G}_{o}^{2}}{8 {π}^{3}} ( \frac{1}{χ} ) & ( 8 )\end{matrix}$$

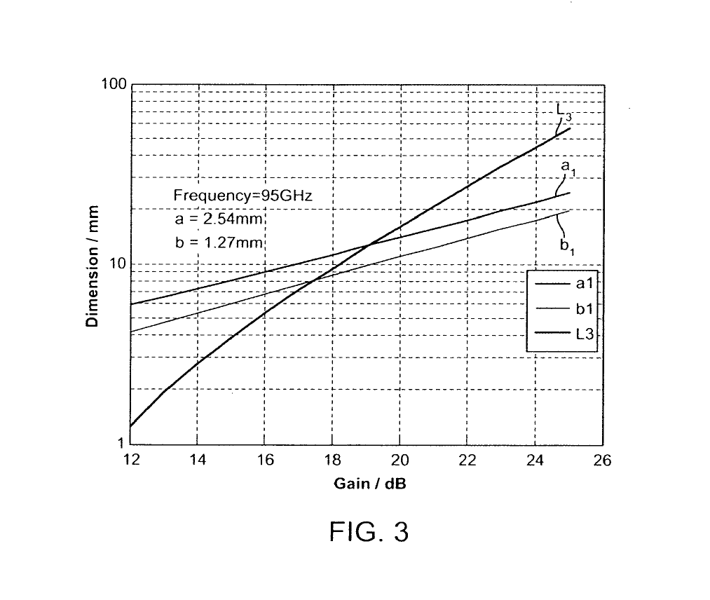

For a specific rectangular waveguide with dimensions “a” and “b”, Eq. (6) can be solved for χ for a desired gain Gₒ. The flare dimensions a₁ and b₁ can then be calculated using Eqs. (4), (7), and Eqs. (5), (8), respectively. FIG. 3 shows the simulation results of the dimensions of the pyramidal horn versus the theoretical gain based on a WR-10 waveguide. For a desired gain of 17 dB, dimensions a₁, b₁, and L₃ are calculated as 10.11 mm, 7.69 mm, and 7.13 mm, respectively. It is noted that higher gain will require larger dimensions and L₃ becomes the dominating dimension when the desired gain is larger than 19 dbB. In one prototype design, a gain of 17 dB was chosen.

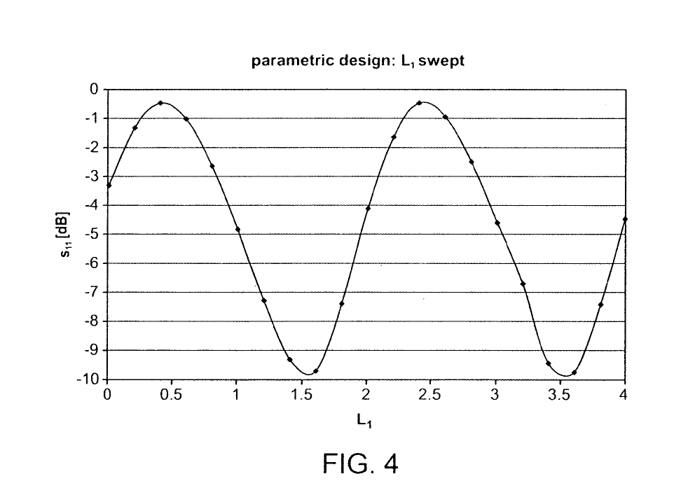

Two resonant cavities of lengths L₁ and L₂ as shown in FIG. 1 were designed in order to match the WR-10 waveguide for horn antenna and to reduce the return loss due to the 90° bend between the waveguide and the horn antenna. In order to find the values for both L₁ and L₂ to maximize the impedance match, a direct search method may be used where the length of each resonant cavity is swept while the other length is fixed until a converging solution is achieved. First, the length of the resonant cavity, L₁, is swept to investigate the s₁₁ responses of the system at 95 GHz using HFSS (HFSS is a finite element-based high frequency structure simulator system) with the second resonant cavity length, L₂, set to zero. It should be noted that the method and the antenna made in accordance with the embodiments of the present invention are not limited to the 95 GHz operating range and that the methods of the present invention can be used with any antenna-waveguide system. An antenna-waveguide system that transmits in the 95 GHz range is useful because it is capable of penetrating fog and rain. The simulation results of the return loss versus L₁ are plotted in FIG. 4 and an impedance match of −9.7 dB is achieved when L₁ is equal to 1.61 mm. It is noted that return loss versus L₁ is periodic with a period of about 2 mm, which corresponds to half the waveguide wavelength at 95 GHz. Afterwards, L₂ is swept in a similar fashion using

HFSS simulations by fixing L₁ at 1.61 mm. It is found that return loss versus L₂ is also periodic with a period of about 2 mm and the first minimum value of −14.5 dB occurs at 1.41 mm. Afterwards, L₁ is again swept by setting L₂ at 1.41 mm and an optimal value is found when L₁ is equal to 1.61 mm. Since the value for L₁ does not change, this implies that convergence has been reached. Therefore, the resonant lengths L₁ and L₂ are set at 1.61 mm and 1.41 mm, respectively.

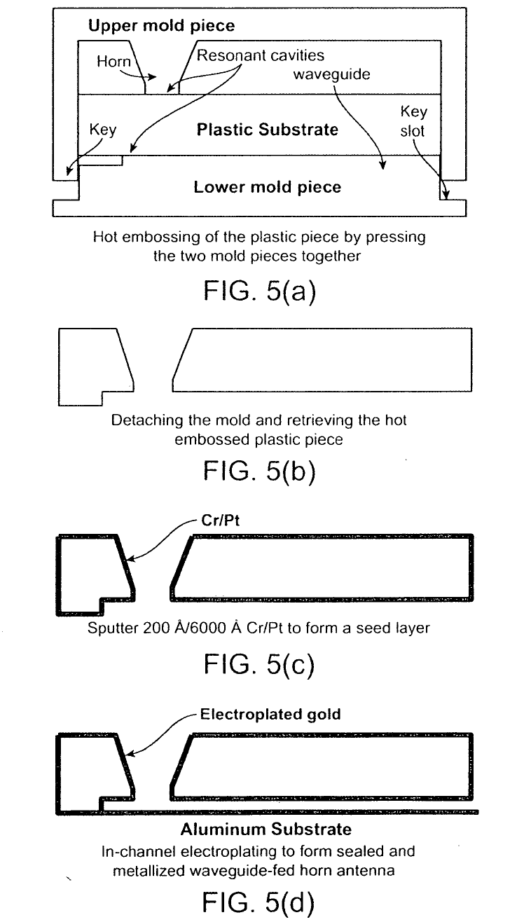

FIGS. 5(a)-(d) illustrate an exemplary self-aligned 3D fabrication process in accordance with one embodiment of the present invention. This 3D micro hot embossing process uses an upper mold piece to construct the horn pattern and the lower mold piece to construct the WR-10 rectangular waveguide. A self-aligned molding process is designed as shown in FIG. 5(a) to have the alignment key on the upper mold piece and key slot on the low mold piece. The mold inserts can be made of aluminum using precision mechanical machines and the self-aligned key and key slot preferably have a tolerance of 12.5 μm such that the maximum possible misalignment is 25 μm. The mold is heated to approximately 320° F. for the Topas® COC polymer and a pressure of 22.64 KPsi is applied. It should be realized that the choice of temperature and pressure are dependent upon the type of polymer that is used to form the waveguide-fed horn antenna, and different plastics or polymers may be used to construct the waveguide-fed horn antenna. A thin layer of polymer material of about 30 μm may remain between the top and bottom mold inserts at the intersection of the pyramidal horn and the waveguide although both mold inserts are contacted in the molding process. This thin residual may be removed (e.g., by using a razor blade) at the completion of the molding process. After the plastic piece is embossed, a 200 Å/6000 Å of Cr/Pt may be sputtered as illustrated in FIG. 5(c). The embodiments of the method of the present invention are not limited to using the Cr/Pt seed layer. Other metal seed layers of differing dimensions that are compatible with the polymer and the later-deposited metal layer may also be used. An aluminum substrate with a seed layer made of Cr/Pt with compositions of 200 Å/6000 Å may be added at the bottom. A plastic flange adaptor may be designed in order to connect the waveguide to a spectrum analyzer and it is separately fabricated using the same hot embossing process and is fitted at the waveguide end. It should be realized that the above-described hot embossing process may be used to form one or more of any shaped pieces. Super glue (e.g., Loctite quicktite) may be used to fix the adaptor with the waveguide-fed antenna. The external surface of the flange facing the spectrum analyzer can be planarized afterwards using a lapping process with a silicon carbide paper of very fine 600-grid mesh. Thereafter, a selective electroplating and sealing process (see, Li-Wei Pan and Liwei Lin, “Batch Transfer of LIGA Microstructures by Selective Electroplating and Bonding,” IEEE/ASME Journal of Microelectromechanical Systems, Vol. 10, pp. 25-32, 2001) is conducted to coat an 8 μm-thick gold layer to seal the system as shown in FIG. 5(d).

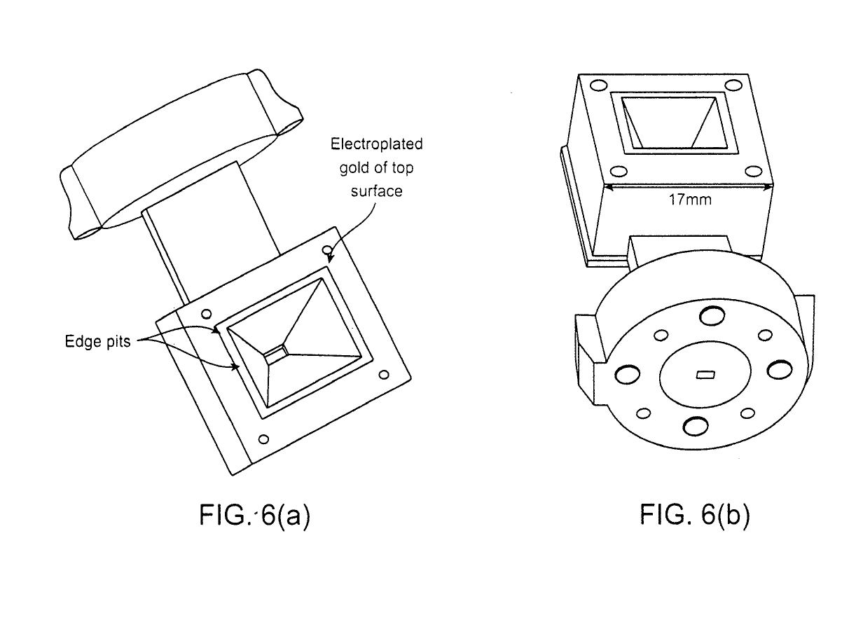

FIG. 6(a) shows the fabricated waveguide-fed horn antenna with a close up view at the horn. During the sputtering and deposition process, Kapton tapes may be applied manually as the masking material to cover areas that do not need the metallic coverage. As a result, an approximately 1 mm-wide electroplated gold layer is deposited around the edge of the top surface as shown and some defects can be identified on the edge between the pyramidal horn and the top flat surface (e.g., edge pits). FIG. 6(b) is the close-up view of the flange portion. The irregular electroplated gold layer on the surface of the flange, which has minimal impact on the manufacture of the horn, can be caused by the seed layer that is patterned using combinations of Kapton tapes.

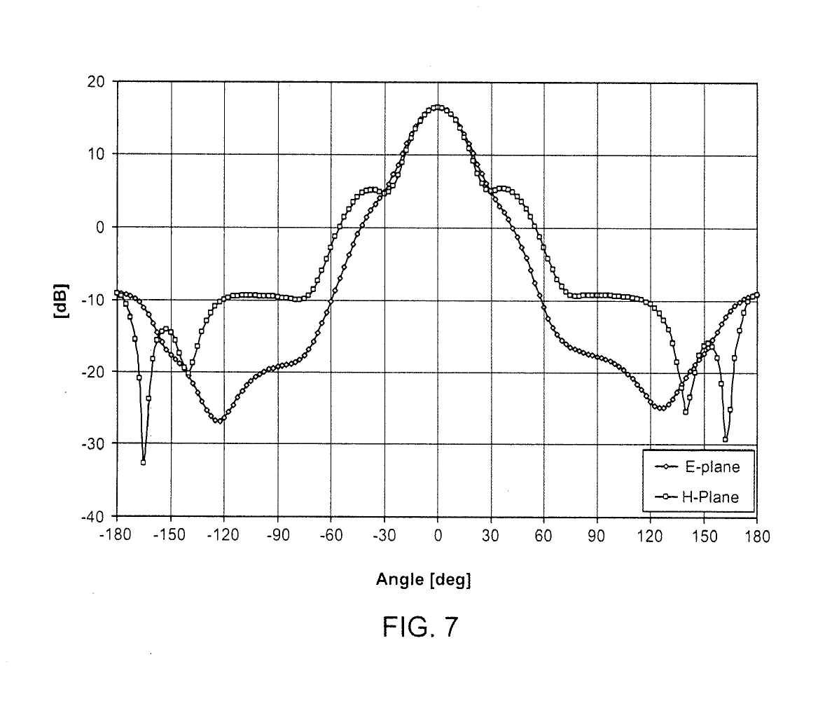

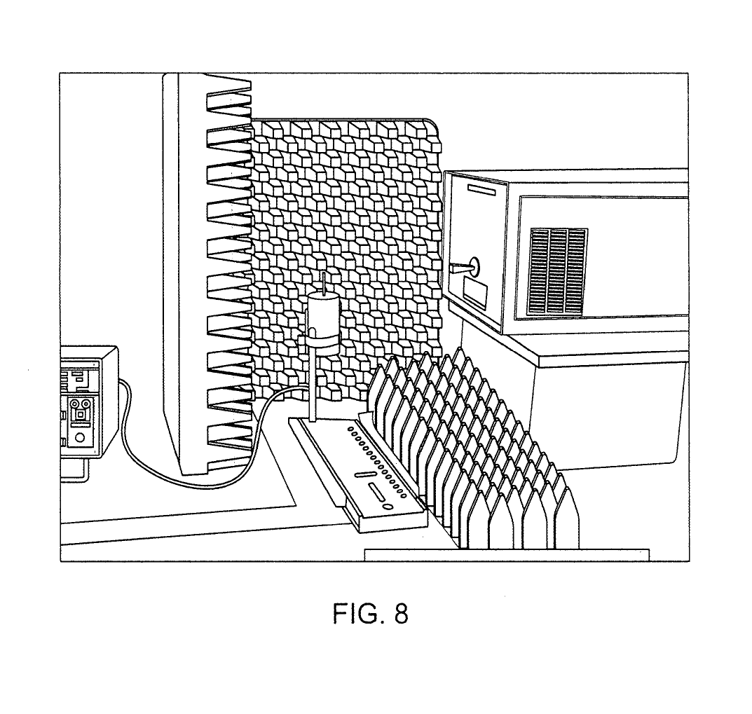

FIG. 7 shows the simulated radiation patterns of the antenna for co-polarized E- and H-planes between −180° to +180° using HFSS. The antenna directivity can be an important parameter in antenna performance characterization and is defined as the ratio of maximum radiated power per unit angle to the average radiated power per unit angle over all directions. Simulation results show a value of 16.56 dB. The radiation pattern of the horn antenna is measured using a millimeter-wave source (Micro-Now Instrument Company Inc., Model 705B Millimeter-wave sweeper/power supply) and a power meter (Millitech Inc., power meter type DPM-01, senor type PMH-10M). FIG. 8 shows the testing set-up for the horn antenna measurements on the performance of co-polarized H-plane. Electromagnetic-wave absorbers have been placed around the testing setup to reduce the reflections.

The space surrounding an antenna can be divided into three radiating regions: (1) reactive field which is the space immediately surrounding the antenna and extends to a distance r=λ/2π where λ is the free-space wavelength; (2) radiating near-field where the field begins to dominate and extends in the region λ/2π<r<2D²/λ where D is the largest dimension of the antenna; and (3) far-field where the angular field distribution is essentially independent of the distance, r, to the antenna and the strength of the field decays as 1/r. It is also desirable to test the antenna in the far-field region. As such, the distance between the reference antenna and the antenna to be characterized should be larger than (see, Constantine A. Balanis, Antenna Theory: Analysis and Design, (John Wiley, 1997), pp. 651-721):

r>2D²/λ (7)

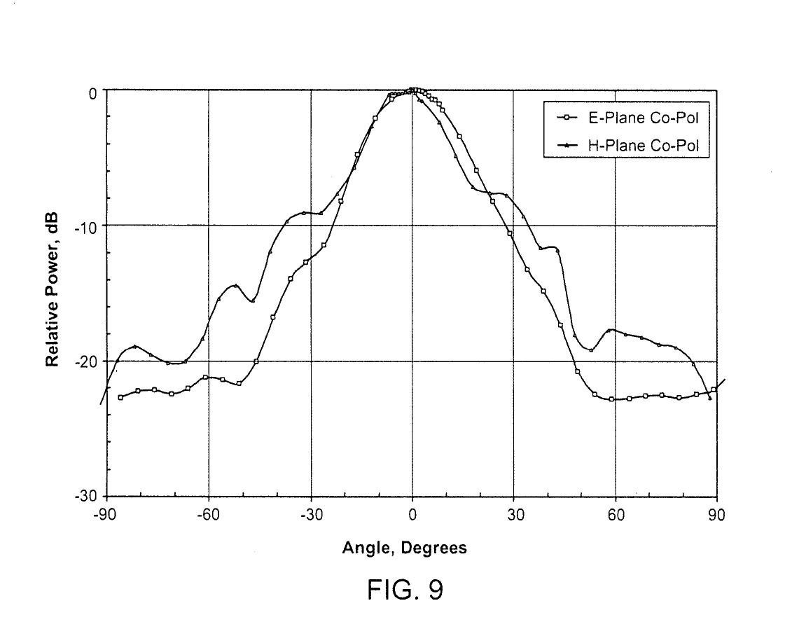

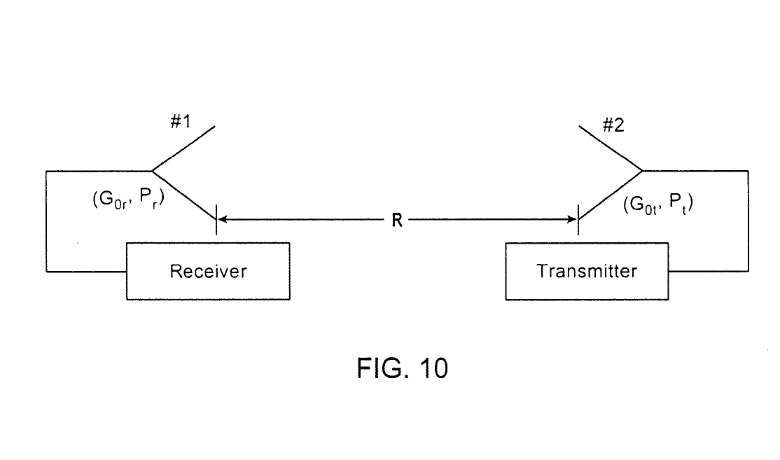

For waves propagating at 95 GHz, a desirable distance in the far-field region is at least 12 cm and the distance between the two antennas is set as 20 cm during the experiments. The measured relative-gain patterns in the co-polarized E- and H-planes are recorded between −90° and +90° as shown is FIG. 9. The 3dB beamwidths of the E- and H-plane patterns are 26° and 23°, respectively. For antennas with one narrow major lobe and one negligible minor lobe, the antenna directivity can be approximated as follows (see, Li-Wei Pan and Liwei Lin, “Batch Transfer of LIGA Microstructures by Selective Electroplating and Bonding,” IEEE/ASME Journal of Microelectromechanical Systems, Vol. 10, pp. 25-32, 2001):

$${D}_{o} = \frac{4 π}{{Θ}_{1 r} {Θ}_{2 r}} \qquad ( 8 )$$

where Θ₁ᵣ and Θ₂ᵣ are the half-power beamwidths in radians measured in two perpendicular planes. At 95 GHz, the measured directivity is calculated as 17.33 dB using Eq. (8). The measured directivity is larger than the simulated directivity and several possible issues may contribute to this result. First, the directivity approximation uses the half-power method and experimental and/or simulation errors can affect the beamwidth measurements. Second, the alignment accuracy between the reference antenna and the antenna to be characterized can also affect the experimental result.

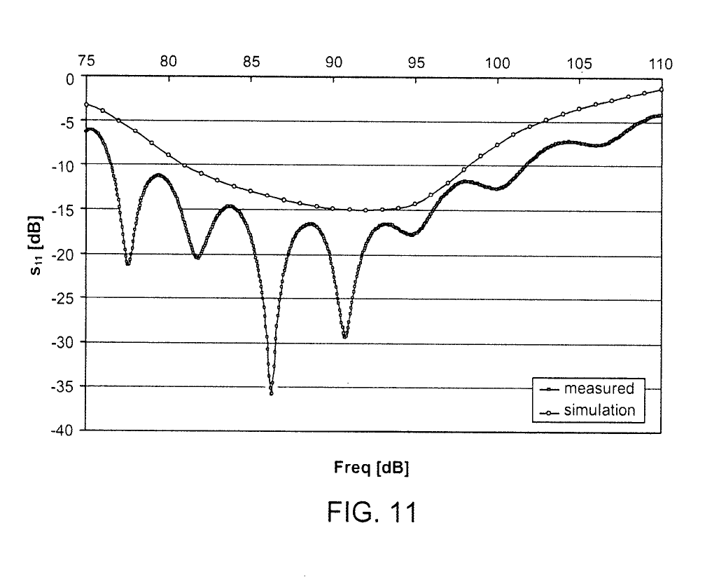

The ratio of the total received power, Pᵣ, relative to the total transmitted power, Pₜ, of the receiver and transmitter antennas separated by a distance R as shown in FIG. 11 can be calculated as follows (see, Constantine A. Balanis, Antenna Theory: Analysis and Design, (John Wiley, 1997), pp. 651-721):

$$\frac{{P}_{r}}{{P}_{t}} = {( \frac{λ}{4 π R} )}^{2} {G}_{0 t} {G}_{0 r} \qquad ( 9 )$$

where λ is the wavelength of the propagating wave, G₀ₜ, is the gain of the transmitter antenna, and G₀ᵣ is the gain of the receiver antenna. The gain of an antenna can be related to its directivity as follows (see, Constantine A. Balanis, Antenna Theory: Analysis and Design, (John Wiley, 1997), pp. 651-721):

G₀=εD₀ (10)

where ε is the antenna efficiency. For the experimental setup shown in FIG. 8, the total transmitted power of the reference antenna is set at 18 dBm with a standard gain of 22 dB. Therefore, the efficiency of the prototype plastic waveguide-fed antenna is calculated as 85%. Some existing metallic antennas have efficiencies close to 95%. The efficiency of the prototype plastic antenna can be further improved by addressing issues in sidewall roughness, signal leakage due to possible sealing problems during the electroplating process, and losses between the interface of DUV and the millimeter-wave meter adaptors.

The return loss s₁₁ of the waveguide-fed horn antenna is measured using an Anritsu ME7808B network analyzer and compared with simulation result using HFSS as shown in FIG. 11. The return loss value at 95 GHz is measured to be 17.5 dB and the 10 dB impedance bandwidth is 22 GHz. It is noted that the measured return loss is better than the simulated return loss by about 3 dB. This can be primarily attributed to the changes in dimensions between the designed and the fabricated antenna. For example, the extra 1 mm-wide gold layer deposited on top of the horn antenna as shown in FIG. 6 is not accounted for in the simulation. However, it may help the transition from the horn antenna to the outer space to increase the transmission and reduce the return loss.

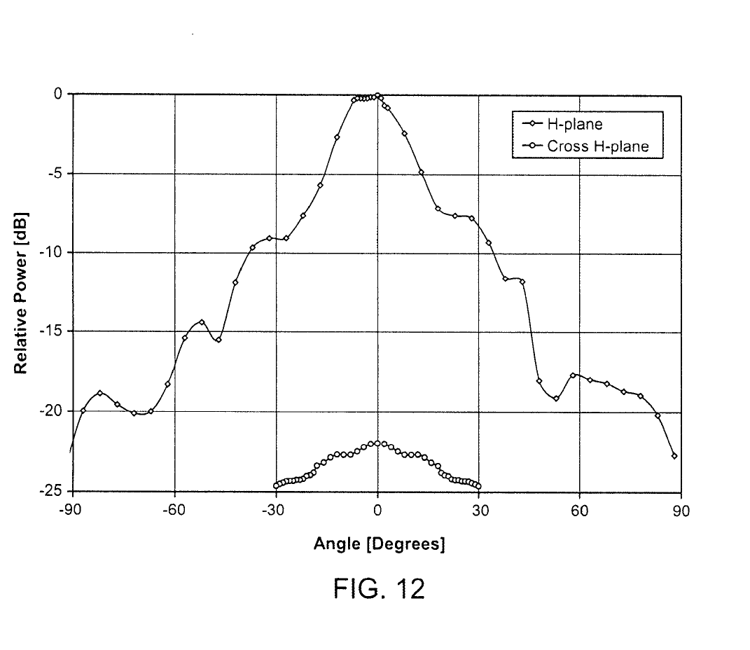

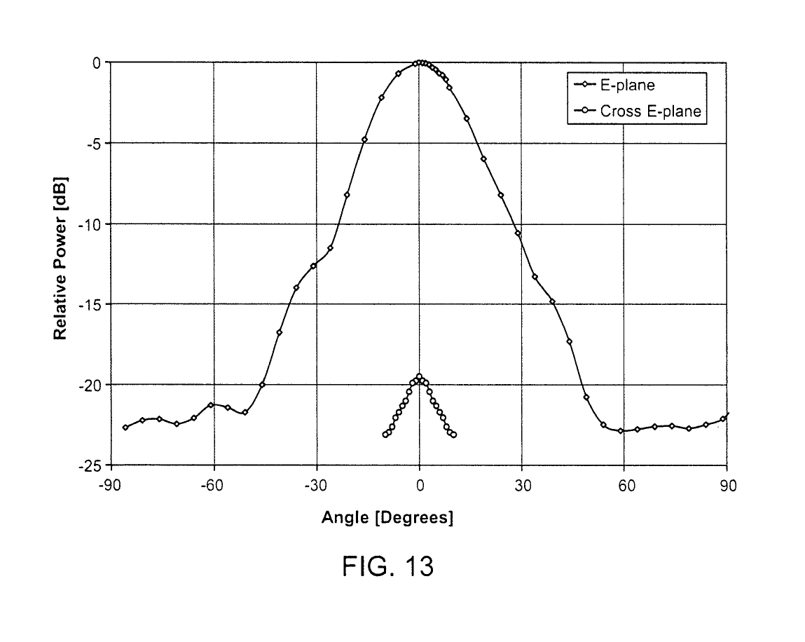

The co-polarized and cross-polarized radiation fields in the H- and E-planes are measured and compared as shown in FIGS. 12 and 13, respectively. The cross-polarized H-plane radiation pattern is lower by about 22.2 dB than the corresponding co-polarized field at the maximum radiation point and is recorded between −30° and +30°. Outside this range, the received power dropped below measurement limit of the power meter. In addition, the cross-polarized E-plane radiation pattern is lower by about 19.5 dB than the corresponding co-polarized field at the maximum radiation point and is recorded between −10° and +10° range. These indicate that the horn antenna is robust in rejecting radiations with different polarizations.

In summary, as described above, plastic pyramidal horn antennas in general and those operating in the W-band fed by a rectangular waveguide can be made using a self-aligned 3D plastic hot embossing process in accordance with the embodiment of the present invention. In the experimental testing for an exemplary antenna, the horn antenna radiation pattern was measured at 95 GHz using a millimeter-wave signal source. The total directivity was measured to be 17.33 dB, very close to the simulated value of 16.56 dB. The horn antenna performance is polarized as the relative power difference between the co- and cross-polarized fields are measured to be better than 19.5 dB and 22.2 dB in the E-plane and H-plane, respectively. The return loss s₁₁ of the waveguide-fed horn antenna was measured as 22 GHz for the 10 dB impedance bandwidth and the return loss at 95 GHz was 17.5 dB. The efficiency of a prototype plastic waveguide-fed antenna was calculated as 85%.

All publications and descriptions mentioned above are incorporated herein by reference in their entireties for all purposes. None is admitted to be prior art.

While the invention has been described in terms of exemplary embodiments, those skilled in the art will recognize that the invention can be practiced with modifications in the spirit and scope of the appended claims. For example, while the invention is described and illustrated herein for the making of a waveguide-fed horn antenna, it may be implemented in a number of other devices. These examples given above are merely illustrative and are not meant to be an exhaustive list of all possible designs, embodiments, applications or modifications of the invention.

What is claimed is:

1. A method for manufacturing a waveguide-fed horn antenna using a three-dimensional, polymeric molding process, comprising:
pressing an upper mold piece and a lower mold piece together to form a plastic work piece with a horn pattern and a waveguide pattern;
depositing an electroplating seed layer onto the molded plastic work piece;
surrounding the embossed plastic work piece with a substrate having an electroplating seed layer; and
electroplating and sealing at least a portion of the molded plastic work piece and the substrate to deposit a metallic layer thereon and connect the plastic work piece with the substrate.

2. The method of claim 1 further comprising providing cavity resonators in the antenna to reduce impedance mismatch between the horn pattern and the waveguide pattern.

3. The method of claim 1 further comprising providing two cavity resonators in the antenna to reduce impedance mismatch between the horn pattern and the waveguide pattern.

4. The method of claim 1 further comprising aligning the upper and lower mold pieces using a key and slot arrangement.

5. The method of claim 1 wherein the polymeric molding process is hot embossing or injection molding.

6. The method of claim 1 wherein depositing an electroplating seed layer comprises sputtering a seed layer.

7. The method of claim 6 wherein sputtering a seed layer comprises sputtering a 200 Å/6000 Å of Cr/Pt.

8. The method of claim 1 further comprising fabricating a flange adaptor and press fitting the adaptor at the waveguide end.

9. The method of claim 1 wherein the metallic layer is gold.

10. The method of claim 1 wherein the substrate is aluminum.

11. The method of claim 1 wherein the substrate is a plastic material.

12. The method of claim 1 wherein the horn pattern comprises a pyramidal shape.

13. The method of claim 1 wherein the waveguide pattern comprises a rectangular shape.

14. The method of claim 1 wherein the plastic work piece comprises Topas COC polymer.

15. A waveguide-fed, horn antenna, comprising:
a plastic body having a horn pattern and a waveguide pattern therein; and
a metallic layer deposited on at least a portion of the plastic body.

16. The antenna of claim 15 further comprising two cavity resonators for reducing impedance mismatch between the horn pattern and the waveguide pattern.

17. The antenna of claim 15 further comprising a flange adaptor press fitted at an end of the waveguide pattern.

18. The antenna of claim 15 wherein the plastic body comprises Topas COC polymer.

19. A method for manufacturing a waveguide-fed horn antenna using a three-dimensional, polymeric molding process, comprising:
pressing an upper mold piece and a lower mold piece together to make an embossed plastic work piece with a horn pattern and a waveguide pattern;
depositing a metal layer onto the embossed plastic work piece;
surrounding the embossed plastic work piece with a second substrate having a metal layer on the surface; and
sealing at least a portion of the embossed plastic work piece with the second substrate to connect two pieces.

20. The method of claim 19 further comprising providing two cavity resonators in the antenna to reduce impedance mismatch between the horn pattern and the waveguide pattern.

21. The method of claim 19 wherein the second substrate is made of plastic material.

22. A method for manufacturing a waveguide-fed horn antenna array using a three-dimensional, polymeric molding process, comprising:
pressing an upper mold piece and a lower mold piece together to hot emboss a plastic work piece with a horn pattern array and a waveguide network pattern;
depositing a metal layer onto the embossed plastic work piece;
surrounding the embossed plastic work piece with a substrate having a metal layer on the surface thereof;
sealing at least a portion of the molded plastic work piece with the substrate to connect the work piece with the substrate; and
providing cavity resonators in each of the antenna to waveguide connections to reduce impedance mismatch between the horn pattern and the waveguide pattern.

23. The method of claim 22 wherein the second substrate is made of plastic material.

24. The method of claim 22 wherein all manufactured antennas in the antenna array are of the same shape and size.

25. A waveguide-fed, horn antenna array, comprising:
a plastic body having a horn pattern array and a waveguide network pattern therein; and
a metallic layer deposited on at least a portion of the system.

26. The horn antenna array of claim 25 wherein the antenna is a W-band antenna.

27. The horn antenna array of claim 25 wherein all antennas in the antenna array comprise same shape and size.

28. The horn antenna array of claim 25 wherein the waveguide network pattern is a part of an array of network patterns, which patterns have different lengths and shapes.
